(19) United States
(12) Patent Application Publication
(10) Pub. No.: US 2004/0231602 A1
(43) Pub. Date: Nov. 25, 2004

(54) Method for determining of moment for insemination of lactating cows

(76) Inventor: Petar Tenchev Atanasov, Chernomorec (BG)

Correspondence Address: John B Hardaway III, Nexsen Pruet Jacobs & Pollard, PO Box 10107, Greenville, SC, 29603, US

(21) Appl. No.: 10/482,421

(22) PCT Filed: Jul. 11, 2002
(86) PCT No.: PCT/BG02/00018

(30) Foreign Application Priority Data
Jul. 12, 2001 (BG) 105700

(51) Int. Cl. A01J 5/00

(52) U.S. Cl. 119/14.02

(57) ABSTRACT

The invention concerns a method for determination of suitable moment for insemination of lactating cows, which seeks the beginning of the sponttaneous lactation during the estrus and the cow is inseminated immediately after that. The milking of the cow right after the insemination is advisable.

### TECHNICAL SCOPE

The following invention refers to a method for determination of suitable moment for insemination of lactating cows with implementation in the field of stockbreeding and especially in insemination of cows.

### PRECEDING STATE OF THE TECHNIQUE

A method for predicting of the insemination of the cows is known (RU 95107421 and RU 2076966), in which 0.02% phouracyline solution is implemented, added to boiling mixture of cervical secret and 4% sodium solution. The mixture is observed for 30-60 seconds and if a stabile light red, rose coloring is observed; a conclusion for 100% insemination ability of the cow could be made.

A disadvantage of this well-known method is the necessity for continuous control, Which must be held up to the suitable moment for insemination. This complicates and makes the insemination procedures expensive, thus forcing the tests to be held by qualified personnel.

### TECHNICAL CORE OF THE INVENTION

The purpose of this invention is to offer a method for determination of suitable moment for insemination of lactating cows, which should be simplified and not involving qualified personnel.

The purpose is gained by developing a method for determination of suitable moment for insemination of lactating cows, for which the observation of the beginning of the spontaneous lactation in the estrus is typical; the cow is inseminated right after that moment.

In one variation after the implementation of the insemination method the cow is milked.

The advantages of the method, according to the invention, are in the fact, that the determination of the most suitable moment for insemination of the cows is made on the base of the natural physical reactions of the cow's organism, without implementation of special techniques. This simplifies the realization of the method and makes the procedure cheaper in whole.

### EXPLANATION OF THE FIGURES INCLUDED

FIG. 1 - Scheme of the lactation after giving birth;

FIG. 2 - Illustrates the lactation of cows in technical milking regime in 6 a.m. and 6 p.m.

FIG. 3 - Illustrates the spontaneous lactation periods;

FIG. 4 - Shows the the 6 hours passive period;

FIG. 5 - Illustrated the cycle of cows with prolonged passive period;

FIG. 6 - Overall scheme, illustrating simultaneously the different cycles and the passive periods;

### EXAMPLES FOR USING THE INVENTION

In conditions of good feeding and taking care of the lactating cows the udder will fill with milk approx. for avg. 12 hours, after that starting spontaneous lactation. When milking is this moment and using proper milking technique, the lactation is at its maximum, the milking itself is easy and the milk quantity is maximal.

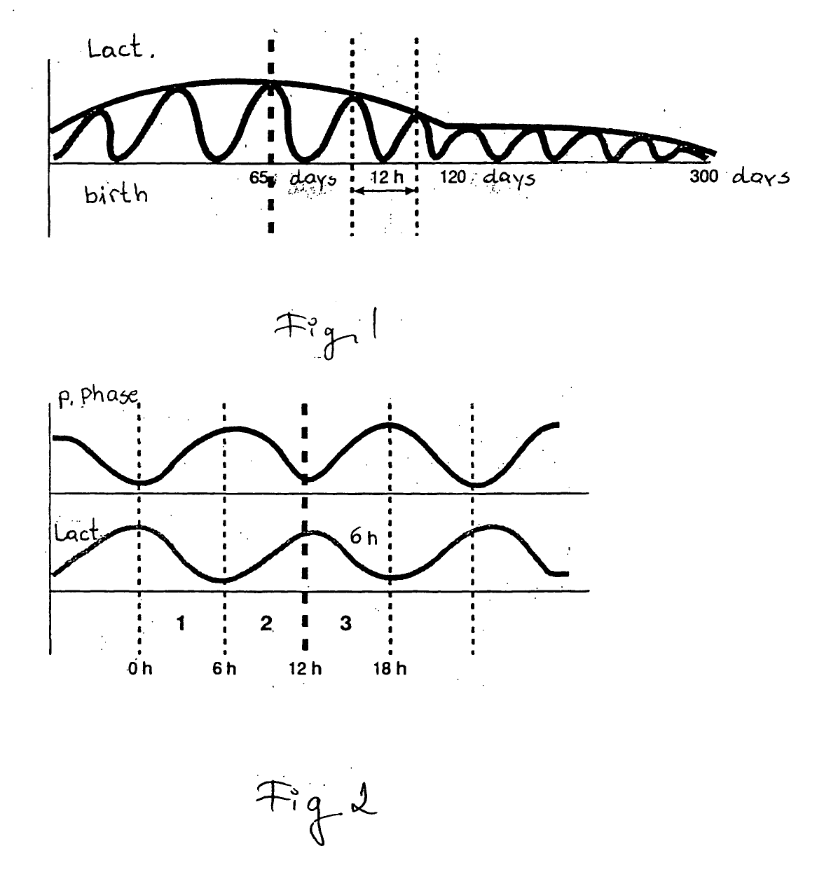

The lactation maximum comes 65 days after the giving birth date, as seen on FIG. 1, this is also the highest insemination ability.

With technological milking regime in 6 a.m. and 6 p.m. an estrus coming succession could be observed, with the following minimums and maximums of lactation in every 12 hours (FIG. 2). The active phase (when the cow doesn't allow sexual contact) is between 1-st and 6-th hour after the beginning of estrus and the passive phase is between 6-th and 12-th hours of the estrus, when spontaneous lactation is observed.

The balancing is from 12-th to the 18-th hour. In this case the most suitable moment for insemination of the cow is the 12-th hour from the beginning of the estrus, when spontaneous lactation from the udder is observed.

If the during morning or evening milking the cow does't give milk and the first symptoms of the passive phase are observed, than the maximum lactation should be observed after 6 hours. During this period the cow allows sexual contact (passive phase). The most suitable moment for insemination is the beginning of the spontaneous lactation, when the optimal probability for furtilazation is reached.

After the insemination individual milking (not in technical schedule) should be done, after that the cow doesn't allow sexual contact. This cycle is shown on FIG. 3 where the passive phase is determined between 6 am and 12 am and 6 pm and 12 pm.

In case the cow shows symptoms of starting the passive phase (i.e. starting of spontaneous lactation) 6 hours after morning or evening milking, than the duration of the passive phase will be also 6 hours.

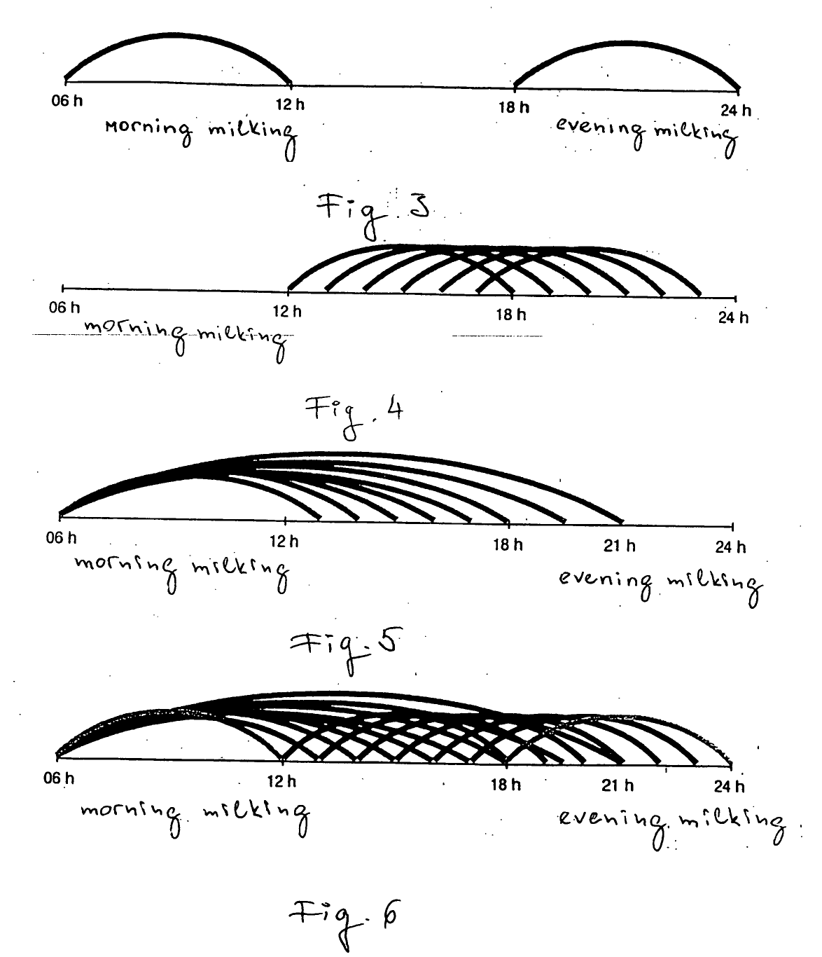

For example if the start of the passive phase is in 12 am. it will continue until 6 pm., meanwhile spontaneous milking is noted; the cow could be inseminated and milked individually. If the start pf the passive phase is in 1 pm its end will be in 7 pm respectively, etc. (see FIG. 4).

In all cases the next milking is desirable to be after 12 hours. During this period of time up to the beginning of the spontaneous lactation the cow is not to be milked.

Is despite the fact the cow is milked the maximum milk quantity is not reached, the passive phase is prolonged for undetermined period, the ovulation is slowed down and there is lower percentage of furtilazation respectively.

The shown above is for cows with synchronized estrus. But there are cows whose passive phase shows up immediately after the morning or evening milking and it prolonged from 7 to 15 hours. That's why for such cows the next spontaneous lactation could not be determined in advance, which imposes individual observation.

Part of the cows show spontaneous lactation symptoms 7-8 hours after the morning or evening milking when the udder is not filled with milk. These cases are shown on FIG. 5 and concern cows with misbalanced estrus synchronization.

The variety of the different cycles of passive phase of different cows is shown on FIG. 6, which is a summary schedule.

1. Method for determination of the suitable moment for insemination of lactating cows, in which the cow is observed and after beginning or during estrus is artificially inseminated, characterized with the fact, that the insemination is done right after beginning of spontaneous lactation during the estrus and after the insemination milking is done.

2. Method for milking of lactating cows, characterized with the fact that the milking is done right after the beginning of spontaneous lactation in biological rhythm.
